(19) United States
(12) Patent Application Publication
(10) Pub. No.: US 2002/0147773 A1
(43) Pub. Date: Oct. 10, 2002

(54) Method and system for panoramic image generation using client-server architecture

(76) Inventor: Herman Herman, Pittsburgh, PA (US)

Correspondence Address: Benjamin T. Queen, II, Pietragallo, Bosick & Gordon, One Oxford Center, 38th Floor, 301 Grant Street, Pittsburgh, PA, 15219, US

(21) Appl. No.: 10/081,433

(22) Filed: Feb. 22, 2002

Related U.S. Application Data
(60) Provisional application No. 60/271,155, filed on Feb. 24, 2001.
(60) Provisional application No. 60/271,154, filed on Feb. 24, 2001.
(60) Provisional application No. 60/315,744, filed on Aug. 29, 2001.
(60) Provisional application No. 60/346,717, filed on Jan. 7, 2002.

(51) Int. Cl. G06F 15/16

(52) U.S. Cl. 709/203

(57) ABSTRACT

In a client-server computer network, a computer implemented method for generating a panoramic image. The method includes transmitting a raw photographic image to the server computer and processing the raw photographic image on the server computer to obtain the panoramic image. Also included are an apparatus, a computer readable medium, and a system for generating a panoramic image using client-server architecture.

### CROSS-REFERENCE TO RELATED APPLICATIONS

This application claims the benefit of U.S. Provisional Application Serial No. 60/271,155 filed Feb. 24, 2001; U.S. Provisional Application Serial No. 60/271,154 filed Feb. 24, 2001; U.S. Provisional Application Serial No. 60/315,744 filed Aug. 29, 2001; and U.S. Provisional Application Serial No. 60/346,717 filed Jan. 7, 2002.

### FIELD OF THE INVENTION

The present invention relates to photographic imaging, and more particularly to method and system for panoramic image generation using client-server architecture.

### BACKGROUND INFORMATION

Recent work has shown the benefits of panoramic imaging, which is able to capture a large azimuth view with a significant elevation angle. If instead of providing a small conic section of a view, a camera could capture an entire half-sphere at once, several advantages could be realized. Specifically, if the entire environment is visible at the same time, it is not necessary to move the camera to fixate on an object of interest or to perform exploratory camera movements. This also means that the view can be supplied to multiple viewers who can independently choose their own view of the environment. A viewer can choose to look to the left and the other can choose to look to the right.

A panospheric camera is a device that captures light from all directions (i.e., 360 degrees), either as stills or as a continuous video stream. The raw images from such a device can be geometrically transformed to synthesize a conventional camera view in any direction. One method for constructing a panospheric camera is to attach a curved mirror to an imaging device, such as a still camera or video camera. The mirror gathers light from all directions and re-directs it to the camera. Both spherical and parabolic mirrors have been used in panoramic imaging systems.

Regardless of the type of device or camera that is used to capture the raw images, the raw images must be converted or processed into panoramic images. The conversion or processing may include, for example, utilizing unwarping software for converting the raw images into a panoramic image format suitable for viewing, such as the panoramic Quicktime VR format. Once the images are converted to the proper panoramic format, a user can view them interactively on a computer.

Currently, to convert the images captured by a camera, the images are first imported to a user computer. The images are then processed to generate the panoramic images on the user computer using processing or unwarping software that is installed on the user's computer. The panoramic images may then be displayed or used on the user computer. However, this process requires that the user purchase the processing software, load the processing software on the user computer, and then process the images. This process, therefore, can be an expensive and difficult process for the user to employ.

There is identified, therefore, a need for an improved method and system for panoramic image generation that overcomes disadvantages, shortcomings, or limitations of known methods and systems for panoramic image generation.

### SUMMARY OF THE INVENTION

Embodiments of the invention meet the identified need, as well as other needs, as will be more fully understood following a review of the specification and drawings.

In accordance with an aspect of the invention, in a client-server computer network, a computer-assisted method for generating a panoramic image is provided. The method includes transmitting a raw photographic image to the server computer and processing the raw photographic image on the server computer to obtain the panoramic image.

In accordance with another aspect of the invention, in a client-server computer network, an apparatus for generating a panoramic image is provided. The apparatus includes means for transmitting a raw photographic image to the server computer and means for processing the raw photographic image on the server computer to obtain the panoramic image.

In accordance with yet another aspect of the invention, in a client-server computer network, a computer readable medium having stored thereon instructions which, when executed by a processor, cause said processor to perform certain steps is provided. The steps include transmitting a raw photographic image to the server computer and processing the raw photographic image on the server computer to obtain the panoramic image.

In accordance with yet an additional aspect of the invention, in a client-server computer network, a system for generating a panoramic image includes a processor and a memory device having data and instructions stored thereon which, when executed by the processor, cause the processor to perform certain steps. The steps include transmitting a raw photographic image to the server computer and processing the raw photographic image on the server computer to obtain the panoramic image.

These and other aspects of the present invention will be more apparent from the following description.

### BRIEF DESCRIPTION OF THE DRAWINGS

FIG. 1 illustrates a raw image in spherical or annular form which may be processed in accordance with the invention to obtain a panoramic image thereof.

FIG. 2 illustrates a 360 degrees cylindrical panoramic view of the raw image shown in FIG. 2.

FIG. 3 illustrates an embodiment of the invention for panoramic image generation.

FIG. 4 illustrates an additional embodiment of the invention for panoramic image generation.

FIG. 5 illustrates yet an additional embodiment of the invention for panoramic image generation.

FIG. 6 illustrates a further embodiment of the invention for panoramic image generation.

### DETAILED DESCRIPTION OF THE INVENTION

Embodiments of the invention provide a method and system for panoramic image generation using client-server architecture. In addition, embodiments of the invention provide an apparatus and a computer readable medium for panoramic image generation using client-server architecture.

As used herein, the term “panoramic image” or “panoramic view” generally refers to wide angle photographic images taken from a field of view of up to 360° around a principal axis, wherein the images also may cover a vertical field of view typically ranging from 0.1° to 180°. These panoramic images can be stored in several different formats such as, for example, Apple Quicktime VR or Microsoft Surround Video.

As used herein, the term “raw image” or “captured image” generally refers to a spherical image, annular image, or other type image that is taken by a camera or similar device that must be converted, processed, or unwarped in order to obtain a panoramic image corresponding thereto.

As used herein, the term “camera” generally refers to any type device capable of capturing a photographic image, either still or video, as a raw image for processing to obtain a panoramic image.

As used herein, the term “client” can be any computer that a user employs to receive, transmit, capture, and/or view the panoramic image.

As used herein, the term “server” can be any computer where the adjustment of the raw image and unwarping of the raw image are done. The server may be connected to the client using either indirect or direct connection which can be temporary or permanent.

It is to be understood that the figures and descriptions of the present invention, and specifically embodiments thereof, have been simplified to illustrate elements that are relevant for a clear understanding of the present invention while eliminating, for purposes of clarity, other elements found in a typical computer network. For example, specific operating system details and modules are not shown. Also, specific network items such as network routers are not shown. In addition, the computers used in conjunction with the present invention may be any type of suitable computer such as, for example, an IBM compatible personal computer, a mainframe computer, an Apple MacIntosh computer, a computer workstation, a handheld computing device or other types of computing and electronic devices. Those of ordinary skill in the art will recognize that other elements are desirable and/or required to produce an operational system incorporating the present invention. However, because such elements are well known in the art, and because they do not facilitate a better understanding of the present invention, a detailed discussion of such elements is not provided herein.

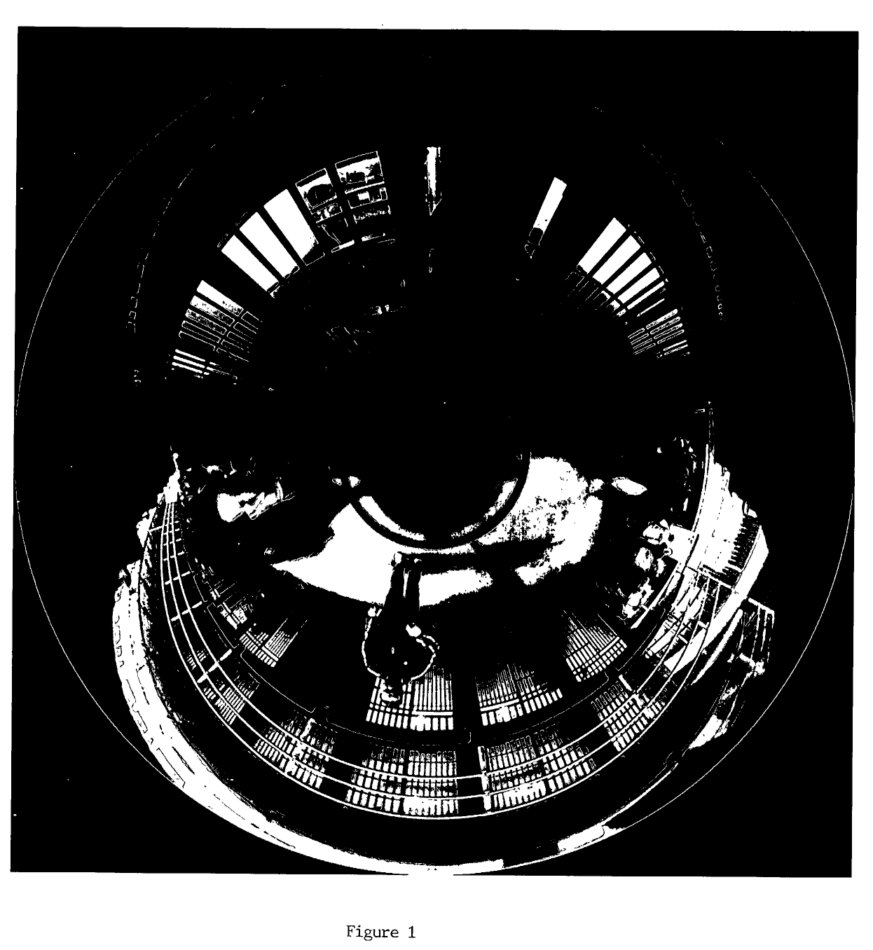

FIG. 1 illustrates a raw image that is captured for processing in accordance with the invention. The raw image is obtained from a camera that is capable of capturing such images for conversion to a panoramic image. The camera may include, for example, a panoramic mirror system used in conjunction therewith such as, for example, the arrangement described in U.S. patent application Ser. No. ______ filed on ______ and entitled Improving Usable Resolution Of Panoramic Mirrors, which is commonly owned by the assignee of the present application and the entire disclosure of which is hereby incorporated by reference. It will be appreciated that other panoramic mirror arrangements and similar type systems for obtaining a raw image for conversion into a panoramic image may be used in conjunction with the present invention.

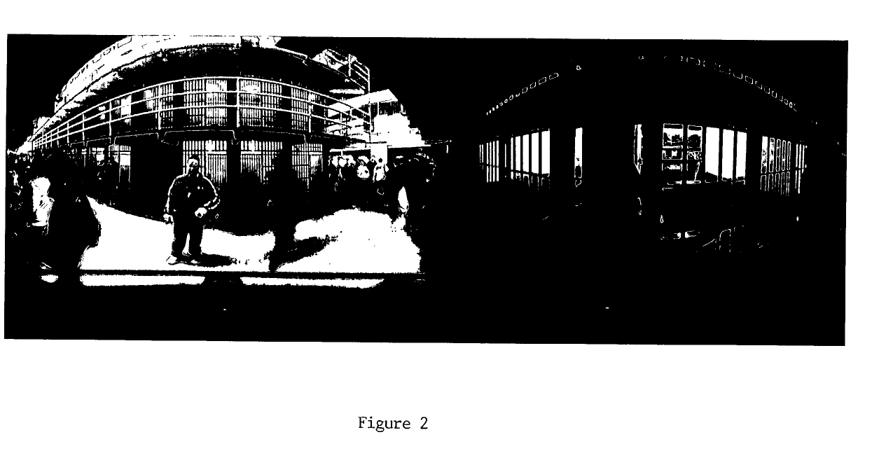

FIG. 2 illustrates a panoramic image in a 360 degrees cylindrical image corresponding to the raw image set forth in FIG. 1. The panoramic image set forth in FIG. 2 is the resulting image following the processing of the raw image. A more common way to display the resulting panoramic image is by using applications such as the Apple Quicktime. This is done by converting the panoramic image to the appropriate format, which in the case of Quicktime VR, the Quicktime VR format. Using such an application, the viewer can interactively view the panoramic image. The viewer can choose the viewing direction and the field of view. Quicktime VR or another player then generates a perspective image of the area that the viewer wants to look at.

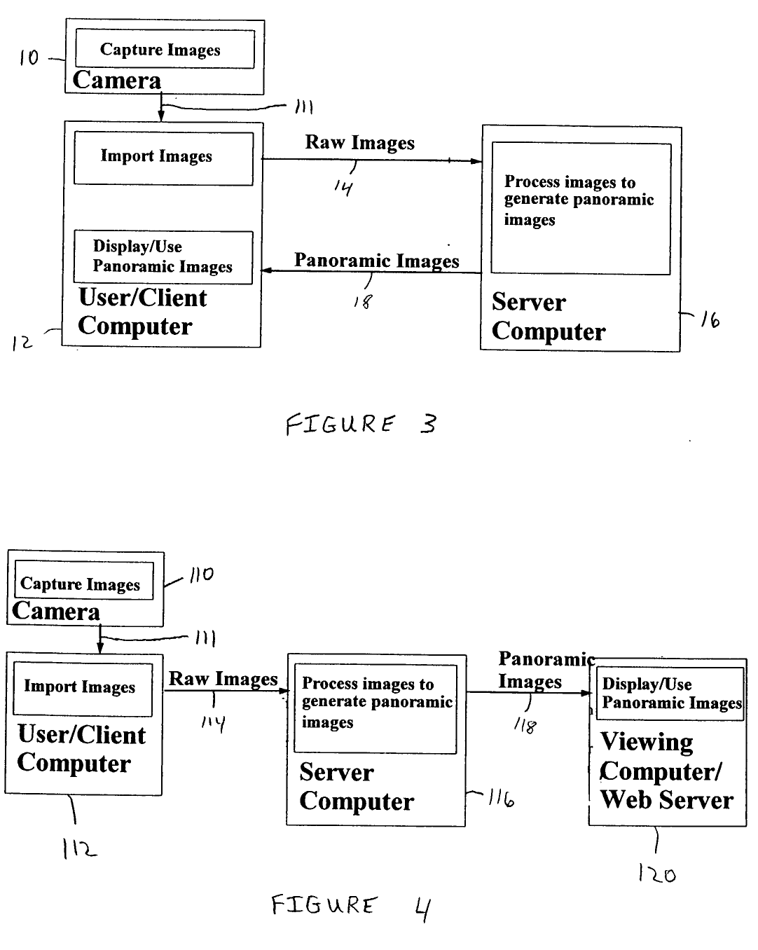

FIG. 3 illustrates a first embodiment of the invention for generating a panoramic image. Specifically, a camera 10 is used for capturing a raw image. The raw image is then imported or transmitted, as illustrated at 11, from the camera to a user or client computer 12. The raw image may be downloaded from the camera 10 to the client computer 12 by a physical connection between the camera 10 and the client computer 12, by storing the captured image on a recording medium and then the client computer 12 reading the data from the recording medium, or by a wireless transmission from the camera 10 to the client computer 12.

Once the raw photographic image is resident on the client computer 12, the image is transmitted, as illustrated at 14, to a server computer 16. The images may be transmitted from the client computer 12 to the server computer 16 using, for example, an Internet connection therebetween, a wireless connection, a phone line, or other suitable networking medium. Furthermore, the images may be transmitted using various network protocols, including e-mail, File Transfer Protocol (FTP), Hypertext Transfer Protocol (HTTP), or other suitable networking protocols.

Once the raw images have been transmitted to the server computer 16 and are resident thereon, the server computer 16 provides a means for processing the raw photographic image to obtain the panoramic image. One aspect of processing the images on the server computer 16 may include utilizing unwarping software installed on the server computer 16 to unwarp the raw images. The unwarping of the image includes converting or processing the raw image to obtain the panoramic image corresponding thereto. The unwarping software may include any such known software for unwarping a raw image to obtain a panoramic image or may include, for example, the unwarping software disclosed in U.S. patent application Ser. No. ______ filed on ______ and entitled Method And Apparatus For Processing Photographic Images, which is commonly owned by the assignee of the present application and the entire disclosure of which is hereby incorporated by reference.

Another aspect of processing the images on the server computer 16 may include adjusting the raw image to orient the raw image either prior to or after obtaining the panoramic image. For example, the adjusting of the raw image may include establishing a center point and radius of the raw image as related to the camera and panoramic mirror arrangement used to obtain the raw image, providing characteristics of the panoramic mirror arrangement such as elevation or vertical field of view, adjusting for incorrect picture angle or correcting the white balance and exposure which may have resulted when the raw image was originally captured by the camera 10.

Still referring to FIG. 3, once the raw image has been processed to obtain a corresponding panoramic image, the panoramic image may then be transmitted, as illustrated at 18, back to the client computer 12. The panoramic image may be transmitted from the server computer 16 to the client computer 12 in a similar manner as described herein for transmitting the raw images from the client computer 12 to the server computer 16.

Once the panoramic images have been transmitted back to the client computer 12 and are resident thereon, a user may then display, view and/or use the processed panoramic images as desired. The client computer 12 should have installed thereon, software capable of viewing the panoramic images, such as Quicktime VR software available from Apple Computer, Inc.

FIG. 4 illustrates an additional embodiment of the invention. This embodiment is similar to that shown in FIG. 3 and described herein, wherein a camera 110 is used to capture a raw image and the image is then imported or transmitted, as illustrated at 111, to a client computer 112. The raw images are then transmitted from the client computer 112, as illustrated at 114, to a server computer 116. The server computer 116 includes suitable software installed thereon for processing the raw image to, for example, obtain a panoramic image, as described herein. The panoramic image is then transmitted, as illustrated at 118, to an additional viewing computer or web server 120, rather than being transmitted back to the client computer 112. The panoramic image may then be viewed and/or used on the viewing computer/web server 120. In addition, the panoramic image can be stored on the viewing computer/web server 120 in order that the panoramic image may be accessed through a network, e.g. the panoramic image may be embedded in a web page or made available for viewing on a particular web page.

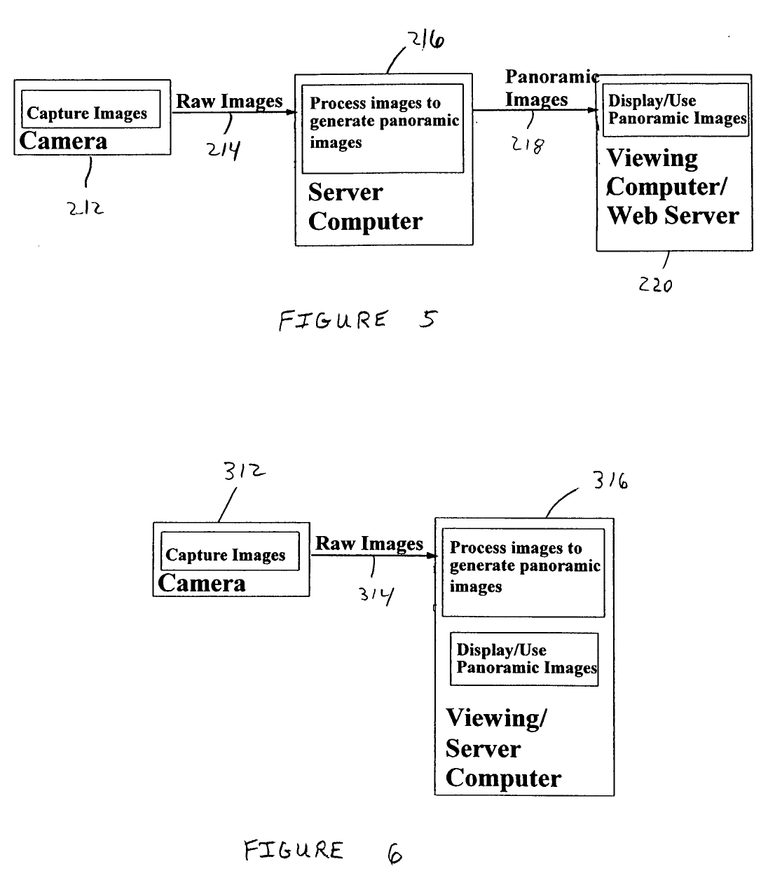

FIG. 5 illustrates yet an additional embodiment of the invention for generating a panoramic image. Specifically, in this embodiment, a camera 212 is used to capture a raw image. Rather than transmitting the captured image from the camera to a user or client computer as illustrated in FIGS. 3 and 4, the raw image may be transmitted, as illustrated at 214, directly to a server computer 216. This transmission may be performed by utilizing a camera, such as a digital camera, with the capability to transmit the images over a network using, for example, a wireless connection or a landline network.

The server computer 216 then processes the raw image to obtain a panoramic image, in a manner similar to the processing described herein in relation to the embodiments set forth in FIGS. 3 and 4. The server computer 216 then transmits the panoramic image, as illustrated at 218, to a viewing computer/web server 220. The viewing computer/web server 220 may then be utilized for further use of the panoramic image, as described herein in relation to the embodiment set forth in FIG. 4.

FIG. 6 illustrates yet an additional embodiment of the invention. Specifically, a camera 312 is used to capture a raw image and then to transmit the raw image, as illustrated at 314, directly to a viewing/server computer 316. Similar to the embodiment set forth in FIG. 5, the camera 312 is preferably a digital camera with the capability to transmit the raw images over a network to the viewing/server computer 316. The viewing/server computer 316 is then capable of processing the raw image to obtain a panoramic image, as described herein for other embodiments. The viewing/server computer 316 is also configured to allow the panoramic image to be viewed directly thereon or to place the processed panoramic image on a network for viewing by a remote computer. In addition, the viewing/server computer 316 is configured to have the panoramic image embedded in a web page for viewing on a computer network.

Accordingly, it will be appreciated that the invention as illustrated, for example, by the embodiments set forth herein provides for panoramic image generation using various client-server architectures. To avoid the complexities and expense of requiring a user to install on a user or client computer processing software for converting or processing a raw image to a panoramic image, the present invention provides for transmitting the raw images to a remote computer, such as the server computer 16, 116, 216, or the viewing/server computer 316, where the processing of the raw image to obtain a panoramic image is performed. The resulting panoramic image is then transmitted back to a user or client computer, such as client computer 12 or 112 or to an additional computer such as viewing computer/web server 220 for displaying or using the panoramic image as desired. In addition, the panoramic image may be placed on a computer network or a web server to allow the panoramic image to be viewed over the network by multiple viewers. An advantage of the invention, therefore, is that no processing software is necessary on the user's computer. Rather, the user can transmit the raw image to a server computer and have the raw image automatically processed to obtain a panoramic image corresponding thereto. The processing/unwarping on the server can be an automatic, unattended process by using software that can automatically make adjustments to the raw image, and then unwarp the raw image. The transmission of the raw image and the panoramic image from one computer to another may be performed using standard available networking software and protocols as described herein.

Another advantage of the invention is that the user can include along with the raw image being transmitted additional information regarding the image. For example, the user may send an e-mail to the server computer which includes the web address to which the processed panoramic image should be forwarded, and the e-mail may include the raw images as attachments thereto. The server computer receives the raw images, automatically processes them to produce panoramic images, and then places the panoramic image at the desired web address. A practical example of such a process is a real estate agent taking a photograph to obtain a raw image and then e-mailing the raw image as attachments to the server computer. In the title or body of the images, the real estate agent can include the web address for the particular property or address of the property that corresponds to the photographic image. The server computer receives the images, processes the images to obtain a panoramic image, and then places the image on the correct web page based on the information that the real estate agent included in the e-mail.

Another advantage of the invention is essentially instantaneous generation of panoramic images by employing the embodiments where a camera having wireless connection capabilities is used to transmit the raw image directly to a server computer for processing to obtain a panoramic image. Thus, the user can use the camera to obtain the raw image and send them directly to the server without having to use a computer at all. The Ricoh RDC-i700 is an example of a digital camera with the ability to send its pictures directly to a server.

Whereas particular embodiments of this invention have been described above for purposes of illustration, it will be evident to those skilled in the art that numerous variations of the details of the present invention may be made without departing from the invention as defined in the appended claims.

What is claimed is:

1. In a client-server computer network, a computer assisted method for generating a panoramic image, comprising:
transmitting a raw photographic image to the server computer; and
processing the raw photographic image on the server computer to obtain the panoramic image.

2. The method of claim 1, further including importing the raw photographic image from a camera to the client computer.

3. The method of claim 2, wherein the transmitting is from the client computer to the server computer.

4. The method of claim 1, wherein the transmitting is from a camera to the server computer.

5. The method of claim 1, wherein the processing of the raw photographic image on the server computer includes unwarping the raw photographic image utilizing unwarping software installed on the server computer.

6. The method of claim 1, wherein the processing of the raw photographic image on the server computer includes adjusting the raw photographic image to orient and correct the exposure and white balance of the raw photographic image prior to obtaining the panoramic image.

7. The method of claim 1, further including transmitting the panoramic image from the server computer to the client computer.

8. The method of claim 7, further including viewing the panoramic image on the client computer.

9. The method of claim 1, further including transmitting the panoramic image to an additional computer for viewing.

10. The method of claim 1, further including embedding the panoramic image in a web page for viewing on a specified computer network.

11. In a client-server computer network, an apparatus for generating a panoramic image, comprising:
means for transmitting a raw photographic image to the server computer; and
means for processing the raw photographic image on the server computer to obtain the panoramic image.

12. The apparatus of claim 11, wherein the raw photographic image is imported from a camera to the client computer.

13. The apparatus of claim 11, wherein the means for processing of the raw photographic image on the server computer includes means for unwarping the raw photographic image.

14. The apparatus of claim 11, wherein the means for processing of the raw photographic image on the server computer includes means for adjusting the raw photographic image to orient the raw photographic image prior to obtaining the panoramic image.

15. The apparatus of claim 11, wherein the panoramic image is transmitted from the server computer to the client computer.

16. The apparatus of claim 11, wherein the panoramic image is transmitted to an additional computer for viewing.

17. The apparatus of claim 11, wherein the panoramic image is embedded in a web page for viewing on a specified computer network.

18. In a client-server computer network, a computer readable medium having stored thereon instructions which, when executed by a processor, cause the processor to perform the steps comprising:
transmitting a raw photographic image to the server computer; and
processing the raw photographic image on the server computer to obtain the panoramic image.

19. The computer readable medium of claim 18, wherein the processing of the raw photographic image on the server computer includes unwarping the raw photographic image utilizing unwarping software installed on the server computer.

20. The computer readable medium of claim 18, wherein the processing of the raw photographic image on the server computer includes adjusting the raw photographic image to orient and correct the exposure and white balance of the raw photographic image prior to obtaining the panoramic image.

21. The computer readable medium of claim 18, further including instructions for transmitting the panoramic image from the server computer to the client computer.

22. The computer readable medium of claim 18, further including instructions for transmitting the panoramic image to an additional computer for viewing.

23. The computer readable medium of claim 18, further including instructions for embedding the panoramic image in a web page for viewing on a specific computer network.

24. In a client-server computer network, a system for generating a panoramic image, comprising:
a processor; and
a memory device having data and instructions stored thereon which, when executed by said processor, cause said processor to perform the steps of:
transmitting a raw photographic image to the server computer; and
processing the raw photographic image on the server computer to obtain the panoramic image.

25. The system of claim 24, further including instructions for importing the raw photographic image from a camera to the client computer.

26. The system of claim 24, wherein the processing of the raw photographic image on the server computer includes unwarping the raw photographic image utilizing unwarping software installed on the server computer.

27. The system of claim 24, wherein the processing of the raw photographic image on the server computer includes adjusting the raw photographic image to orient and correct the exposure and white balance of the raw photographic image prior to obtaining the panoramic image.

28. The system of claim 24, further including instructions for transmitting the panoramic image from the server computer to the client computer.

29. The system of claim 24, further including instructions for transmitting the panoramic image to an additional computer for viewing.

30. The system of claim 24, further including instructions for embedding the panoramic image in a web page for viewing on a specified computer network.

31. A client-server system for generating a panoramic image, wherein the server is configured to receive requests from the client, send responses to the client, and wherein the server is further configured to:
receive a raw photographic image from the server computer; and
process the raw photographic image on the server computer to obtain the panoramic image.

32. The system of claim 31, wherein the server is further configured to unwarp the raw photographic image utilizing unwarping software installed on the server computer.

33. The system of claim 31, wherein the server is further configured to adjust the raw photographic image to orient and correct the exposure and white balance of the raw photographic image.
